(19) United States
(12) Patent Application Publication
(10) Pub. No.: US 2002/0052296 A1
(43) Pub. Date: May 2, 2002

(54) Herbicidal synergistic combination of a dihydrobenzothiophene compound and a photosystem II inhibitor

(75) Inventors: Albert Cleve Everson JR., Cary, NC (US); Timothy Patrick Miller, Apex, NC (US); Aldo Angelo Morelli, Wanaque, NJ (US); Charles Lawrence Ortlip, Levittown, PA (US); Brian James Dahlke, Mahomet, IL (US); Wayne Lynn Tucker, Philo, IL (US)

Correspondence Address: BASF Corporation, Intellectual Property Department, P.O. Box 400, Princeton, NJ, 08543-0400, US

(73) Assignee: Intellectual Property Department, BASF Aktiengesellschaft, Ludwigshafen (DE)

(21) Appl. No.: 09/938,372

(22) Filed: Aug. 24, 2001

Related U.S. Application Data
(60) Provisional application No. 60/228,327, filed on Aug. 25, 2000.

(51) Int. Cl. A01N 43/56; A01N 43/647; A01N 43/713; A01N 43/72; A01N 43/64; A01N 43/60

(52) U.S. Cl. 504/139; 504/133; 504/136

(57) ABSTRACT

The present invention provides a method for the synergistic control of undesirable plants which comprises applying to said plants or their locus a synergistically effective amount of a combination of a dihydrobenzothiophene compound of formula I plus a Photosystem II inhibitor.

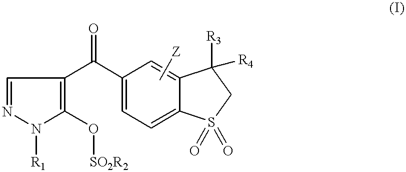

Further provided are synergistic herbicidal compositions comprising a dihydrobenzothiophene compound and a Photosystem II inhibitor.

### BACKGROUND OF THE INVENTION

Dihydrobenzothiophenes such as those described in U.S. 5,607,898 and WO 97/08164 demonstrate excellent herbicidal activity. However, said dihydrobenzothio-phenes, when used as the sole active ingredient, do not always achieve effective control of the full spectrum of weed species encountered in commercial agronomic practice at application rates required for acceptable crop safety. Such gaps in the spectrum of control can often be remedied by co-treatment with another herbicide known to be effective against the target weed species. However, the increased application rates required when additional herbicides are needed for effective weed control are undesirable and burdensome to the farmer and the environment.

Therefore it is an object of this invention to provide a synergistic, crop-selective herbicidal combination which provides effective broad-spectrum weed control at lower application rates.

It is another object of this invention to provide a synergistic herbicidal composition useful for the effective control of a broad spectrum of weeds in the presence of a crop and which may be applied at a diminished rate.

### SUMMARY OF THE INVENTION

The present invention provides a method for the control of undesirable plants which comprises applying to said plants, plant seeds, tubers or other propagating organs thereof or to the soil or water in which they are growing a synergistically effective amount of a combination of a dihydrobenzothiophene compound of formula I

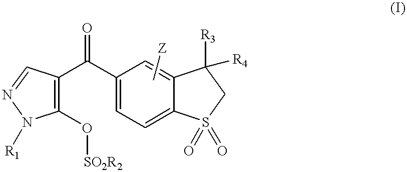

wherein

R₁ is C₁-C₄ alkyl;

R₂ is C₁-C₈ alkyl, C₃-C₈ cycloalkyl, or phenyl

optionally substituted with one or more

halogen, NO₂, C₁-C₄ alkyl, C₁-C₄ alkoxy, or C₁-C₄

haloalkyl groups;

R₃ and R₄ are each independently hydrogen or C₁-C₄

alkyl; and

Z is hydrogen or halogen plus a Photosystem II inhibitor herbicide.

The present invention also provides a synergistic herbicidal composition which comprises an agriculturally acceptable carrier and a synergistically effective amount of a combination of a dihydrobenzothiophene compound of formula I plus a Photosystem II inhibitor herbicide.

### DETAILED DESCRIPTION OF THE INVENTION

Dihydrobenzothiophene (DHBT) compounds of formula I

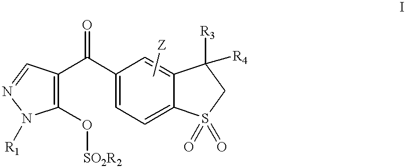

and methods for their preparation are described in U.S. 5,607,898 and WO 97/08164. Said compounds demonstrate excellent herbicidal activity. However, said compounds, when used as the sole active ingredient, do not always achieve effective control of the full spectrum of weed species encountered in commercial agronomic practice, when applied at rates which demonstrate desirable crop safety.

Surprisingly, it has now been found that a combination of a DHBT compound of formula I and a Photosystem II inhibitor herbicide provides synergistic control of troublesome weeds such as Panicum, Digitaria, Brachiaria, Echinochloa, Sorghum, Elyrtigia, Setaria, and Senna. That is, the application of the combination of the invention gives a mutual reinforcing action such that the application rates of the individual herbicidal components can be reduced and still the same herbicidal effect is achieved or, alternatively, the application of the combination of herbicidal components demonstrates a greater herbicidal effect than that which could be expected from the effect of the application of the individual herbicidal components when applied alone at the rate at which they are present in the combination (synergistic effect).

Advantageously, the synergistic combination of the invention allows for lower application rates of said DHBT compound with concomitant increased spectrum of weed control. Moreover, the synergistic herbicidal methods and compositions of the invention allow for effective resistance management.

The organic moieties mentioned for the substituents R¹ to R⁴ or as radicals on phenyl rings represent collective terms for individual enumerations of the individual group members. All hydrocarbon chains, ie. All alkyl, haloalkyl, alkoxy moieties can be straight chain or branched. Unless otherwise specified, halogenated substituents preferably have attached to them one to five identical or different halogen atoms. Halogen means in each case fluorine, chlorine, bromine or iodine.

Examples for other meanings are:

C₁-C₂ alkyl: methyl or ethyl;

C₁-C₄ alkyl: C₁-C₂ alkyl as mentioned above, and also n-propyl, 1-methylethyl, butyl, 1-methylpropyl, 2-methylpropyl or 1,1-methylethyl;

C₁-C₈ alkyl: C₁-C₄ alkyl as mentioned above, and also pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylbutyl, 1-ethyl-1-methylpropyl or 1-ethyl-3-methylpropyl, heptyl or octyl;

C₁-C₄ haloalkyl: C₁-C₄ alkyl as mentioned above which are partially or fully substituted by fluorine, chlorine, bromine and/or iodine, eg. chloromethyl, dichloromethyl, trichloromethyl, fluoromethyl, difluoromethyl, trifluoromethyl, chlorofluoromethyl, dichlorofluoromethyl, chlorodifluoromethyl, 2-fluoroethyl, 2-chloroethyl, 2-bromoethyl, 2-iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromoethyl)-2-bromoethyl, 4-fluorobutyl, 4-chlorobutyl, 4-bromobutyl or nonafluorobutyl;

C₁-C₄ alkoxy: methoxy, ethoxy, propyoxy, 1-methylethoxy, butoxy, 1-methylpropoxy, 2-methylpropoxy or 1, 1-methylethoxy.

As used in the specification and claims, Photosystem II inhibitor designates a herbicide which is capable of inhibiting at least one of two reaction centers found in plant chloroplasts wherein photosynthesis occurs. Examples of Photosystem II inhibitors suitable for use in the method of the invention include metribuzin; pyridate; bromoxynil; bentazon; triazines such as atrazine, cyanazine, simazine, ametryn, or the like; or ureas such as linuron, diuron, chlortoluron, isoproturon or the like; preferably triazines.

Preferred DHBT compounds of formula I are those compounds wherein

R¹ is C₁-C₄ alkyl;

R² is C₁-C₈ alkyl, C₃-C₈ cycloalkyl or phenyl optionally substituted with one or more halogen, NO₂, C₁-C₄ alkyl, C₁-C₄ alkoxy or C₁-C₄ haloalkyl groups;

especially C₁-C₄-alkyl;

R³ and R⁴ are each independently hydrogen or C₁-C₄ alkyl;

especially hydrogen or C₁-C₂ alkyl; and

Z is hydrogen or halogen;

especially hydrogen.

Also preferred DHBT compounds of formula I are those compounds wherein

R₁ is C₁-C₂ alkyl;

R₂ is C₁-C₄ alkyl;

R₃ and R₄ are each independently hydrogen or C₁-C₂ alkyl; and

Z is hydrogen.

Especially preferred DHBT compounds of formula I are those compounds wherein Z is linked in 4-position to the 2,3-dihydrobenzo[b]thienyl moiety.

A preferred inventive synergistic combination is one wherein the formula I compound is the 1-propanesulfonic acid ester of 2,3-dihydro-3,3,4-trimethylbenzo [b]thien-5-yl 5-hydroxy-1 -methylpyrazol-4-yl ketone S,S-dioxide (hereinafter designated compound IA)

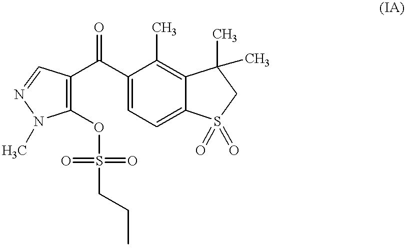

plus a photosystem II inhibitior such as a triazine herbicide, preferably atrazine or cyanazine.

In accordance with the method of invention a synergistically effective amount of a combination of a DHBT compound and a Photosystem II inhibitor herbicide may be applied to the locus, foliage or stems of undesirable plants, such as Panicum, Digitaria, Brachiaria, Echinochloa, Sorghum, Elyrtigia, Setaria, or Senna, optionally in the presence of a crop, such as a soybean or a cereal crop such as wheat, barley, rice, corn, rye or the like, preferably corn.

The synergistically effective amount employed in the method of the invention may vary according to prevailing conditions such as the particular Photosystem II inhibitor used, weed pressure, application timing, weather conditions, soil conditions, mode of application, topographical character, target crop species or the like.

Preferred combinations useful in the method of the invention are those combinations wherein the weight/weight ratio of the formula I DHBT compound to the Photosystem II inhibitor herbicide is about 1:2.5 to 1:180, especially 1:10 to 1:100.

In actual practice, the combination of the invention may be applied sequentially or simultaneously as a co-formulation, a tank mix or a premix.

The present invention also provides a synergistic herbicidal composition comprising an agriculturally acceptable carrier and a synergistically effective amount in of a combination of a DHBT compound of formula I and a Photosystem II inhibitor herbicide. The agriculturally acceptable carrier may be an inert solid or a liquid. While not required, the combination compositions of the invention may also contain other additives such as fertilizers, inert formulation aids, i.e. surfactants, emulsifiers, defoamers, dyes, extenders or any of the conventional inert ingredients typically employed in herbicidal formulated products.

Compositions according to the invention may be formulated in any conventional form, for example as an emulsifiable concentrate, a concentrated emulsion, a microemulsion, a suspension concentrate, a soluble granule, a dispersible granule, a dust, a dust concentrate, a wettable powder or the like. Solvents (liquid carrier) used in this invention may be aromatic hydrocarbons, eg. Solvesso® 200, substituted naphthalenes, phtalic acid esters (such as dibutyl or dioctyl phthalate), aliphatic hydrocarbons (eg. cyclohexane or paraffins), alcohols and glycols (as well as their ethers and esters, eg. ethanol, ethyleneglycol mono- and dimethyl ether), ketones (such as cyclohexanone), stronly polar solvents (such as N-methyl-2-pyrrolidone, or γ-butyrolactne), higher alkyl pyrrolidines (e.g. n-octylpyrrolidone or cyclohexylpyrrolidone), epoxidized plant oil esters (e.g. methylated coconut or soybean oil ester) and water. Mixtures of solvents are also suitable.

Solid carriers, which may be used for making formulations of the invention in the form of dusts, wettable powders, water dispersible granules, or granules, may include mineral fillers, such as calcite, talc, kaolin, montmorillonite or attapulgite. The physical properties of such formulations may be modified or improved by addition of highly dispersed silica gel or polymers, if desired. Carriers for granules according to the invention may be porous material, e.g. pumice, kaolin, sepiolite, bentonite; or non-sorptive material, eg. calcite or sand. Additionally, a multitude of pre-granulated inorganic or organic material may be used, such as dolomite or crashed plant residues.

Pesticidal compositions of this invention may also embrace surfactants. Suitable surfactants (surface active agent) for this invention include non-ionic, anionic, cationic and zwitterionic substances having good dispersing, emulsifying and wetting properties. The suitability of a surfactant for a particular formulation may be readily determined by those skilled in the art based on the nature of the DHBT to be formulated. Mixtures of individual surfactants may also be used.

A composition according to the present invention preferably contains from 0.5% to 95% by weight (w/w) of active ingredients.

The compositions of this invention can be applied to the plants, plant seeds, tubers or other propagating organs thereof or to the soil or water in which they are growing simultaneously with or in succession with other active substances. These other substances can be either fertilizers, agents which donate trace elements or other preparations which influence plant growth. However, they can also be further herbicides, insectices, fungicides, bactericides, nematicides, algicides, molluscicides, rodenticides, virucides, compounds inducing resistance into plants, biological control agents such as viruses, bacteria, nematodes, fungi and other microorganisms, repellents of birds and animals, and plant growth regulators, or mixtures of these preparations, if appropriate together with the other carrier substances conventionally used in the art of formulation, surfactants or other additives which promote application.

The synergistically effective amount of the combination of a DHBT compound and a Photosystem II inhibitor suitable for use in the composition of the invention is that amount sufficient to provide about 12 g/ha-100 g/ha of the DHBT compound and 32 g/ha-4000 g/ha of a Photosystem II inhibitor herbicide. In another preferred embodiment the amount of DBHT compound is 1 g/ha-50 g/ha and the amount of Photosystem II inhibitor is 100 g/ha-500g/ha.

For a more clear understanding of the invention, specific examples thereof are set forth below. These examples are merely illustrative, and are not to be understood as limiting the scope and underlying principles of the invention in any way.

In the following examples, synergism for two-way combinations is determined by the Colby₁ method, i.e. the expected (or predicted) response of the combination is calculated by taking the product of the observed response for each individual component of the combination when applied alone divided by 100 and subtracting this value from the sum of the observed response for each component when applied alone. Synergism of the combination is then determined by comparing the observed response of the combination to the expected (or predicted) response as calculated from the observed responses of each individual component alone. If the observed response of the combination is greater than the expected (or predicted) response then the combination is said to be synergistic and falls within the definition of synergistic effect as previously defined.

The foregoing is illustrated mathematically below, wherein a two-way combination, C₂, is composed of component X plus component Y and Obs. designates the observed response of the combination C₂.

$$( X + Y ) - \frac{XY}{100} = Expected response ( Exp . )$$

$$Synergism ≡ Obs . > Exp .$$

### Example 1

### Evaluation of the Herbicidal Activity of Combinations of Atrazine and

### DHBT IA

In this evaluation, seedlings of the plant species listed below are grown in Metromix® soil in jiffy flats for about two weeks, to the 2-3 leaf growth stage. The test compounds are dispersed in water containing 1.0% Sunit II, a methylated seed oil of Agsco, Inc., and applied to the plants through a spray nozzle operating at 40 psi for a predetermined time so as to obtain a range of application rates of about 3.0 g/ha to 250 g/ha. Each treatment is replicated 3 times. After spraying, the plants are placed on greenhouse benches and are cared for in accordance with conventional greenhouse procedures. Eighteen days after treatment, the seedling plants are examined and the % weed control as compared to the untreated check is recorded.

Data obtained are reported in Tables I and II. For replicated treatments, the data are averaged. The Colby method of analysis is used to determine the resultant biological effect of the combination treatment as compared to the biological effect of each component when applied alone. In Tables I and II, obs designates observed and exp designates expected.

TEST COMPOUNDS USED
Atrazine - AATREX ® 4L, manufactured by Novartis
DHBT IA - formulated as a suspension concentrate (SC)

| | |
|---|---|
| | (IA) |
| 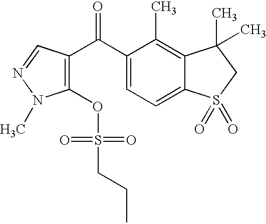 | |

PLANT SPECIES USED

| Column Heading | Common Name | Scientific Name |
|---|---|---|
| PANDI | Fall panicum | Panicum dichotomiflorum |
| DIGSA | Crabgrass, large | Digitaria sanguinalis |
| ERBVI | Cupgrass, woolly | Eriochloa villosa |
| BRAPP | Signalgrass, broadleaf | Brachiaria platyphylla |
| ECHCG | Barnyardgrass | Echinochloa crus-galli |
| SORHA | Johnsongrass | Sorghum halepense |
| SORBI | Shattercane | Sorghum bicolor |
| AGRRE | Quackgrass | Elytrigia repens |
| PANMI | Millet, wild proso | Panicum miliaceum |
| SETVI | Foxtail, green | Setaria viridis |
| SETFA | Foxtail, giant | Setaria faberi |
| CASOB | Sicklepod | Senna obtusifolia |
| ZEAMX | Corn | Zea mays |

TABLE I
Evaluation of the Herbicidal Activity of Combinations of Atrazine and DHBT IA

| | | % WEED CONTROL | | | | | | | | | | | | | |
|---|---|---|---|---|---|---|---|---|---|---|---|---|---|---|---|
| Test | RATE | PANDI | | DIGSA | | ERBVI | | BRAPP | | ECHCG | | SORHA | | SORBI | |
| Compd | (g/ha) | Obs | Exp | Obs | Exp | Obs | Exp | Obs | Exp | Obs | Exp | Obs | Exp | Obs | Exp |
| Atrazine | 250 | 5 | | 15 | | 10 | | 20 | | 85 | | 0 | | 0 | |
| DHBT IA | 3.00 | 40 | | 50 | | 0 | | 25 | | 45 | | 35 | | 30 | |
| DHBT IA | 6.00 | 55 | | 70 | | 15 | | 55 | | 60 | | 40 | | 35 | |
| DHBT IA | 12.0 | 75 | | 85 | | 40 | | 100 | | 80 | | 65 | | 60 | |
| Atrazine + | 250 | 95 | 43 | 75 | 58 | 35 | 10 | 100 | 40 | 100 | 92 | 60 | 35 | 65 | 30 |
| DHBT IA | 3.00 | | | | | | | | | | | | | | |
| Atrazine + | 250 | 100 | 57 | 90 | 75 | 55 | 24 | 100 | 64 | 100 | 94 | 50 | 40 | 70 | 35 |
| DHBT IA | 6.00 | | | | | | | | | | | | | | |
| Atrazine + | 250 | 100 | 76 | 95 | 87 | 75 | 46 | 100 | 100 | 100 | 97 | 80 | 65 | 95 | 60 |
| DHBT IA | 12.0 | | | | | | | | | | | | | | |

As can be seen from the data shown in Table I, application of a combination of a DHBT compound plus a Photosystem II inhibitor herbicide gives significantly greater weed control than that which could be predicted from the weed control resulting from the application of either compound alone.

TABLE II
Evaluation of the Herbicidal Activity of Combinations of Atrazine and DHBT IA

| Test | | % WEED CONTROL | | | | | | | | | | | |
|---|---|---|---|---|---|---|---|---|---|---|---|---|---|
| Com- | RATE | AGRRE | | PANMI | | SETVI | | SETFA | | CASOB | | ZEAMX | |
| pound | (g/ha) | Obs | Exp | Obs | Exp | Obs | Exp | Obs | Exp | Obs | Exp | Obs | Exp |
| Atrazine | 250 | 45 | | 60 | | 90 | | 85 | | 40 | | 0 | |
| DHBT IA | 3.00 | 20 | | 40 | | 35 | | 35 | | 15 | | 0 | |
| DHBT IA | 6.00 | 30 | | 70 | | 100 | | 55 | | 25 | | 0 | |
| DHBT IA | 12.0 | 35 | | 95 | | 80 | | 90 | | 25 | | 0 | |
| Atrazine + | 250 | 70 | 56 | 100 | 76 | 100 | 94 | 100 | 90 | 70 | 49 | 0 | 0 |
| DHBT IA | 3.00 | | | | | | | | | | | | |
| Atrazine + | 250 | 100 | 62 | 100 | 88 | 100 | 100 | 100 | 93 | 90 | 55 | 0 | 0 |
| DHBT IA | 6.00 | | | | | | | | | | | | |
| Atrazine + | 250 | 100 | 64 | 100 | 98 | 100 | 98 | 100 | 99 | 85 | 55 | 0 | 0 |
| DHBT IA | 12.0 | | | | | | | | | | | | |

As can be seen from the data shown in Table II, application of a combination of a DHBT compound plus a Photosystem II inhibitor herbicide gives significantly greater weed control than that which could be predicted from the weed control resulting from the application of either compound alone.

What is claimed is:

1. A method for the synergistic control of undesirable plants which comprises applying to said plants, plant seeds, tubers or other propagating organs thereof or to the soil or water in which they are growing a synergistically effective amount of a combination of a compound of formula I 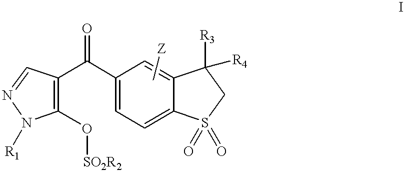
wherein
R₁ is C₁-C₄ alkyl;
R₂ is C₁-C alkyl, C₃-C₈ cycloalkyl, or phenyl optionally substituted with one or more halogen, NO₂, C₁-C₄ alkyl, C₁-C₄ alkoxy, or C₁-C₄ haloalkyl groups;
R₃ and R₄ are each independently hydrogen or C₁-C₄ alkyl; and
Z is hydrogen or halogen plus a Photosystem II inhibitor herbicide.

2. The method according to claim 1 wherein the Photosystem II inhibitor herbicide is selected from the group consisting of metribuzin, pyridate, bromoxynil, bentazon, a triazine herbicide, and an urea herbicide.

3. The method according to claim 2 wherein said Photosystem II herbicide is a triazine herbicide.

4. The method according to claim 3 wherein said triazine is atrazine or cyanazine.

5. The method according to claim 1 having a compound of formula I wherein
R₁ is C₁-C₂ alkyl;
R₂ is C₁-C₄ alkyl;
R₃ and R₄ are each independently, hydrogen or C₁-C₂ alkyl; and
Z is hydrogen.

6. The method according to claim 5 wherein the formula I compound is the 1-propanesulfonic acid ester of 2,3-dihydro-3,3,4-trimethylbenzo[b]thien-5-yl 5-hydroxy-1-methylpyrazol-4-yl ketone S,S-dioxide.

7. The method according to claim 1 wherein the formula I compound and the Photosystem II inhibitor are present in a wt/wt ratio of about 1:2.5 to 1:180.

8. A synergistic herbicidal composition which comprises an agriculturally acceptable carrier and a synergistically effective amount of a combination of a compound of formula I 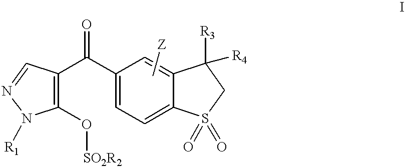
wherein R₁, R₂, R₃, R₄, and Z are as defined in claim 1, and a Photosystem II inhibitor herbicide.

9. The composition according to claim 8 wherein the Photosystem II inhibitor herbicide is selected from the group consisting of metribuzin, pyridate, bromoxynil, bentazon, a triazine herbicide and a urea herbicide.

10. The composition according to claim 9 wherein said Photosystem II herbicide is a triazine herbicide.

11. The composition according to claim 10 wherein said triazine herbicide is atrazine or cyanazine.

12. The composition according to claim 8 having a compound of formula I wherein
R₁ is C₁-C₂ alkyl;
R₂ is C₁-C₄ alkyl;
R₃ and R₄ are each independently, hydrogen or C₁-C₂ alkyl and
Z is hydrogen.

13. The composition according to claim 12 wherein said formula I compound is the 1-propanesulfonic acid ester of 2,3-dihydro-3,3,4-trimethylbenzo [b]thien-5-yl 5-hydroxy-1-methylpyrazol-4-yl ketone S,S-dioxide.

14. The composition according to claim 8 wherein the synergistically effective amount is about 12 g/ha-100 g/ha of compound of formula I and about 32 g/ha-4000 g/ha of a Photosystem II inhibitor herbicide.
